(19) United States
(12) Patent Application Publication
(10) Pub. No.: US 2006/0275205 A1
(43) Pub. Date: Dec. 7, 2006

(54) Hydrogen extraction from gases derived from solid hydrocarbon fuels using mixed oxide ion/electronic conducting membranes

(75) Inventors: Kevin Krist, Palatine, IL (US); Estela T. Ong, Chicago, IL (US); Robert J. Remick, Bolingbrook, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE

(21) Appl. No.: 11/145,329

(22) Filed: Jun. 3, 2005

(51) Int. Cl. C01B 3/02

(52) U.S. Cl. 423/648.1

(57) ABSTRACT

A method for extracting hydrogen from a hydrogen-containing gas mixture in which a first side of a mixed oxide ion/electronic conducting membrane is contacted with the hydrogen-containing gas mixture and the opposite side of the mixed oxide ion/electronic conducting membrane is contacted with steam, forming steam on the first side of the mixed oxide ion/electronic conducting membrane and hydrogen gas on the opposite side of the mixed oxide ion/electronic conducting membrane. The hydrogen-containing mixture in accordance with one embodiment of this invention is derived from the gasification of a solid hydrocarbon fuel, such as coal or biomass.

### BACKGROUND OF THE INVENTION

1. Field of the Invention

This invention relates to a method for extracting hydrogen from a mixture of gases comprising hydrogen. More particularly, this invention relates to a method for extracting hydrogen from synthesis gases derived from the gasification of solid hydrocarbon fuels, such as coal and biomass. This invention also relates to the use of mixed oxide ion/electronic conducting membranes for the hydrogen-extracting process.

2. Description of Related Art

Solid hydrocarbon fuels such as coal and biomass are converted to gaseous fuels at high temperatures by partial oxidation with air and/or steam. Exemplary of such conversions are processes taught by U.S. Pat. Nos. 4,057,402 and 4,369,045 (coal gasification) and U.S. Pat. Nos. 4,592,762 and 4,699,632 (biomass gasification). Synthesis gases produced by these processes comprise primarily hydrogen and carbon monoxide, typically with a hydrogen/CO molar ratio in the range of about 0.6 to about 6.0. Because of the abundance of solid hydrocarbon fuels, they are potentially major sources of hydrogen, particularly if cost effective means for extracting the hydrogen from the gaseous fuel products can be devised.

Gasification of solid hydrocarbon fuels is carried out at high temperatures in the range of about 600° C. to about 1400° C. Although these temperatures favor the kinetics of chemical reactions, materials selection for use in hydrogen separation is often limited to ceramics. For example, mixed proton/electron conducting ceramics can be used to selectively separate hydrogen from a mixture of gases. The mechanism of hydrogen separation using a mixed proton/electronic ceramic membrane is shown in FIG. 1. As shown therein, a hydrogen-containing gas is introduced on the feed side of the membrane. H₂ is dissociated on the membrane surface into protons and electrons. The protons and electrons are transported through the membrane to the opposite surface, the permeate side of the membrane, where they recombine to form H₂. The membrane selectivity to H₂ is substantially 100%. The flux is expressed as

$${J}_{{H}_{2}} = - \frac{RT}{4 {F}^{2} L} \frac{( {σ}_{{H}^{+}} ) ( {σ}_{el} )}{( {σ}_{{H}^{+}} + {σ}_{el} )} ( ln ( {p}_{{H}_{2}}^{f} ) - ln ( {p}_{{H}_{2}}^{p} ) )$$

where R is the gas constant, F is the Faraday constant, L is the membrane thickness, σ_{H}_{⁺} is the proton conductivity, σₑₗ is the electronic conductivity, P_{H}_{ₛ}^{f} is the partial pressure of hydrogen on the feed side of the membrane and p_{H}_{₂}^{p} is the partial pressure of hydrogen on the permeate side. The term

$$\frac{( {σ}_{{H}^{+}} ) ( {σ}_{el} )}{{σ}_{{H}^{+}} + {σ}_{el}} = {σ}_{amb}$$

is called ambipolar conductivity. Thus, the flux is dependent on 1/L, T, σ_{amb}, and
(ln(p_{H}_{₂}^{f})−ln(p_{H}_{₂}^{p})).

However, mixed proton/electronic conductors have a number of shortcomings including poor strength and reactivity with gasified fuel species such as CO₂ and H₂S. In addition, H₂ separation from the fuel gases renders the spent fuel vulnerable to carbon deposition, which can cover membrane surfaces and inactivate the membrane.

The method of this invention for extraction of hydrogen from solid hydrocarbon fuels, which employs a mixed ionic (oxide)/electronic conducting membrane, overcomes at least some of the disadvantages of conventional proton-conducting membrane hydrogen separation processes.

U.S. Pat. No. 5,306,411 teaches solid membranes comprising an intimate, gas impervious, multi-phase mixture of an electronically-conductive material and an oxygen-conductive material and/or a mixed metal oxide of a perovskite structure for use in electrochemical reactors in which oxygen is transported from an oxygen-containing gas to a gas or mixture of gases that consume oxygen, more particularly for partial oxidation of methane to produce unsaturated compounds or synthesis gas, the partial oxidation of ethane, substitution of aromatic compounds, extraction of oxygen from oxygen-containing gases, including oxidized gases, ammoxidation of methane, etc. The focus of the teachings of the '411 patent is the conversion of an oxygen-consuming gas, such as methane, to produce other useful gases, e.g. synthesis gas. Accordingly, in the case where methane is disposed on one side of the mixed ionic/electronic conducting membrane and air is disposed on the opposite side of the membrane, as the air contacts the membrane, the oxygen component of the air is reduced to oxygen ions which are transported through the membrane to the methane side of the membrane where the oxygen ions react with the methane to produce synthesis gas comprising primarily hydrogen and carbon monoxide or to produce olefins, depending upon the reaction conditions. In accordance with another embodiment, the oxygen-containing gas on one side of the membrane is a gas containing steam, i.e. H₂O gas. The H₂O contacts the membrane resulting in reduction of the oxygen in the H₂O to oxygen ions which are transported across the membrane to the opposite side where they react with methane or natural gas to produce a synthesis gas (primarily H₂ and CO) and the H₂O on the first side of the membrane is reduced to hydrogen, which may be recovered and used for any number of purposes.

### SUMMARY OF THE INVENTION

The invention described herein is a method for the extraction of hydrogen from a synthesis gas produced by the gasification of solid hydrocarbon fuels, such as coal and biomass, in which the first side (oxygen-consuming gas side) of a mixed oxide ion/electronic conducting membrane is contacted with the synthesis gas, a gaseous mixture comprising hydrogen gas and carbon monoxide, and the opposite side (oxygen-containing gas side) of the mixed oxide ion/electronic conducting membrane is contacted with steam, resulting in the formation of water and/or steam on the first side of the mixed oxide ion/electronic conducting membrane and hydrogen gas on the opposite side of the mixed oxide ion/electronic conducting membrane. Thus, in contrast to the teachings of the '411 patent, in which the hydrogen gas on the oxygen-containing gas side of the membrane is formed by the partial oxidation of methane or other hydrocarbon gas with the oxygen ions transported across the membrane, the only oxygen-consuming reactant on the oxygen-consuming gas side of the mixed oxide ion/electronic conducting membrane employed in accordance with the method of this invention is hydrogen.

### BRIEF DESCRIPTION OF THE DRAWINGS

The objects and features of this invention will be better understood from the following detailed description taken in conjunction with the drawings, wherein:

FIG. 1 is a schematic diagram showing the mechanism of hydrogen separation using a conventional mixed proton/electronic conducting membrane; and

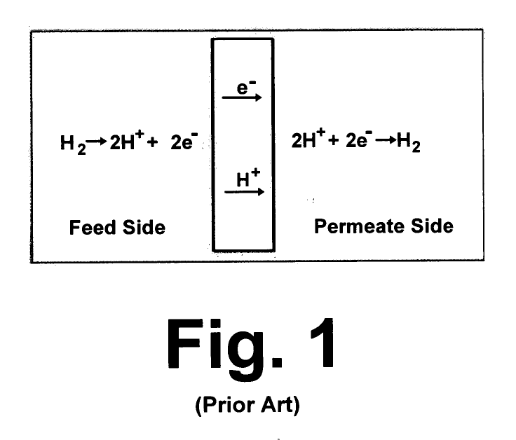

FIG. 2 is a schematic diagram showing the mechanism of hydrogen separation using a mixed oxide ion/electronic conducting membrane in accordance with the method of this invention.

### DETAILED DESCRIPTION OF THE PRESENTLY PREFERRED EMBODIMENTS

The terms “oxygen-consuming gas”, “reactant gas” and “oxygen-containing gas” as used herein include materials which are not gases at temperatures below the temperature ranges of the method of this invention, and may include materials, such as the oxygen-containing gas steam, which is liquid at room temperature.

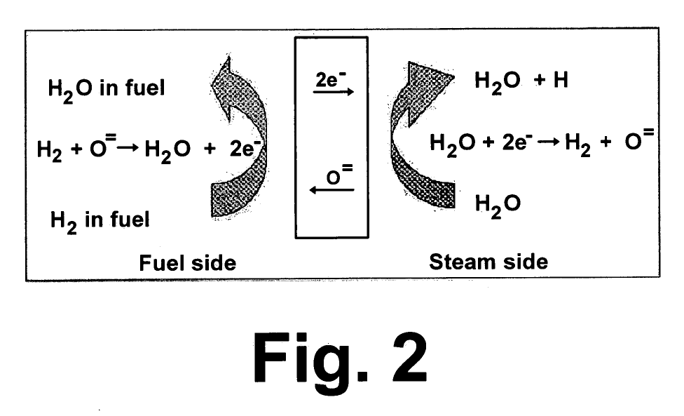

As previously indicated, the method of this invention relates to the extraction of hydrogen from a solid hydrocarbon gasification environment by virtue of steam electrolysis. The separation membrane is a mixed oxide/electron conducting material, typically ceramic, as described in more detail hereinbelow. The separation process of the method of this invention is shown in FIG. 2. As shown therein, hydrogen, H₂, in the synthesis fuel gas contacting the membrane on oxygen-consuming gas side of the membrane reacts with surface oxide to form water and electrons. The electrons are transported to the oxygen-containing gas side of the membrane where the oxygen-containing gas, i.e. steam, dissociates the water in the steam into H₂ and oxide ion. The oxide ion is conducted back to the oxygen-consuming gas side of the membrane while the H₂ on the oxygen-containing gas side of the membrane is carried away by the sweeping steam. The net process of this invention is
H_{2 fuel}+H₂Oₛₜₑₐₘ→H₂O_{fuel}+H_{2 steam},
the separation of H₂ from its initial gaseous environment into a simple process stream containing steam. The process may, therefore, be useful in separating H₂ from complex, high-temperature gas environments such as coal- or bio-gas. The method is equivalent to pressure driven H₂—depolarization of high temperature steam electrolysis, and the flux is, therefore, expressed as

$${J}_{{H}_{2}} = - \frac{RT}{4 {F}^{2} L} \frac{( {σ}_{{O}^{=}} ) ( {σ}_{el} )}{( {σ}_{{O}^{=}} + {σ}_{el} )} ( ln ( {p}^{f} {H}_{{H}_{2} O} ) + ln ( {p}_{{H}_{2}}^{S} ) - ln ( {p}_{{H}_{2}}^{f} ) - ln ( {p}_{{H}_{2} O}^{S} ) )$$

with notations similar to those of the proton conductors previously described.

The method of this invention provides several advantages over the conventional method of hydrogen separation employing proton conducting membranes. First, whereas with the proton conducting membrane, the driving force for proton conduction is dependent only upon the H₂ partial pressure difference across the membrane, the steam partial pressure difference is an added factor that favors the oxide conducting membrane employed in the method of this invention. For representative gasification conditions, this means a higher thermodynamic driving force for H₂ production using the oxide conducting membrane compared to the conventional proton conducting membrane.

Second, the oxygen transported to the oxygen-consuming gas side of the membrane can be helpful to the gasification process from which the synthesis gas on the oxygen-consuming gas side of the membrane is produced. In particular, the increased oxygen content may help to convert any hydrocarbon species which may be present and, thus, prevent carbon deposition. In addition, due to the anticipated oxygen, it is likely that the amount of external air introduced to the gasification reactor vessel can be reduced.

Third, conductivity of the oxide conducting membrane can be one order of magnitude greater than that of proton conducting membranes, resulting in potentially higher fluxes with the oxide conducting membrane.

Fourth, because the electron conductivity of the oxide conducting membrane is also high, the membranes may not require a metal phase.

Fifth, unlike proton conducting membranes, oxide conducting membranes are generally stable against CO₂.

Sixth, because the choice for oxide ion-conducting membrane materials is wider, there is a greater chance that a membrane composition stable against H₂S can be designed, for example membranes based upon yttria-stabilized zirconia.

Mixed oxide ion/electronic conducting membranes suitable for use in the method of this invention generally fall into one of three categories. The first of these categories is a membrane comprised of single phase materials having both oxide ion and electronic conductivity. Exemplary of such materials are perovskites such as LaCoO₃, La_{0.6}Sr_{0.4}CoO₃, La_{0.2}Sr_{0.8}CoO₃, YCoO₃, YBa₂Cu₃Ox., and doped CeO₂. Among these materials, La_{0.2}Sr_{0.8}CoO₃ shows the highest oxide flux. Gd-doped CeO₂ has a simple chemical composition and is a good candidate material. However, at high temperatures it could reduce under some oxide-consuming gas environments to Ce₂O₃, in which case its oxide ion conductivity may suffer. Nevertheless, it may be particularly suitable for use in connection with biomass gasification reactors, which generally have a lower operating temperature than other solid hydrocarbon fuel gasification reactors, such as coal gasifiers.

A second category of mixed oxide ion/electronic conducting membranes suitable for use in the method of this invention are cermets comprising an oxide ion conductor and a metal as an electronic conductor. Exemplary of suitable oxide conductors are Y₂O₃₋, CaO⁻ and Sc₂O₃-doped ZrO₂, doped or undoped CeO₂, ThO₂, and Bi₂O₃. Suitable metals are selected from the group consisting of Ag, Au, Pt, Rh, Ru, Pd, Ni, Co, Cu, Ta, Nb, V, and combinations thereof. Metal addition may be minimal if the metal phase is made to thinly coat the surface of the oxide grains. This can be achieved by such techniques as vapor deposition and soaking in solutions of soluble metal salt solutions. For example, doped zirconia powder may be soaked in an aqueous solution of nickel nitrate. Upon drying, the coated powder is heated to remove the nitrate leaving NiO on the zirconia surface. The powder is then further processed by conventional techniques to form the membrane, which microstructurally consists of sintered grains with a fine interdispersed NiO phase that can provide electrical conductivity. The amount of NiO may be small so as to just provide random electrical connection across the membrane. Upon operation in the oxygen-consuming gas environment, the NiO is reduced to Ni with volume reductions that could create voids. However, because the amount of NiO added is small, the pores created may be acceptable.

A third category of mixed oxide ion/electronic conducting membranes suitable for use in the method of this invention are dual phase ceramics comprising an oxide conductor as described above and an electron conducting oxide. Exemplary of suitable electron conducting oxides are Pr—In oxide, Ce—La oxide, Nb—Ti oxide, Ce₂O₃, and Sn—In oxide, as well as doped lanthanum chromate. Good ionic-conducting candidates are Y₂O₃₋, CaO⁻ and Sc₂O₃-doped ZrO₂ based membranes due to their exceptionally high temperature capabilities and chemical stabilities. However, without additive, ZrO₂-based membranes lack electronic conductivity. A good electronic conducting oxide additive for ZrO₂ is Ce₂O₃.

In addition to composition, there are additional design considerations for membranes suitable for use in the method of this invention, for example fabricability and hydrogen separation flux. In accordance with one embodiment of this invention, the mixed oxide ion/electronic conducting membranes employed in the method of this invention are thin, supported membranes. Depending upon the speed of the reactions occurring at the surfaces of the membrane, thinner membranes result in higher hydrogen extraction fluxes. In accordance with one preferred embodiment of this invention, membrane thicknesses are preferably 20 microns or less. These thin membranes are supported with a thicker porous substrate for handleability and strength. Preferably, although not required, the support is made of the same material as the membrane so that there is no thermal mismatch and chemical reactions occurring between layers. The support is porous to enable the reactant gases to reach the membrane surface.

In accordance with another preferred embodiment of this invention, symmetrical membranes with catalytic surfaces are employed. Kinetics of reactions between membrane surfaces and the gas phase may limit the supply and removal of oxygen flux. To address these limitations, in accordance with one embodiment of this invention, a catalyst such as Ni, Co, Pt and/or Pd may be incorporated into the porous layer of the membrane to improve the reaction kinetics. As a result, the membrane will be sandwiched between two porous layers, one containing catalyst favoring steam dissociation and the other containing catalyst favoring H₂ oxidation. With this configuration, thermal stresses between the membrane and the two support layers neutralize each others effect on the membrane.

Interlayers may be added between porous supports on either side of the membrane and on the membrane itself. These interlayers may contain different compositions or morphologies to enhance surface reactions and provide a suitable surface for membrane deposition. Suitable materials for use as interlayers include the materials of the three types of membranes discussed herein above having a different microstructure from the microstructure of the porous support and the membrane. The interlayers improve reaction surface area while providing a transition between the membrane materials and the support materials. For scenarios in which the operating temperature of the membrane is relatively low, e.g. 700° C., the desirability of using interlayers will increase due to the fact that at the lower temperatures, surface reactions are slower. In accordance with one preferred embodiment of this invention, the interlayers have a finer microstructure, resulting from the use of smaller grain size materials, and lower porosity than the supports to enhance surface reactions and provide a better surface for depositing thin, dense membranes. In accordance with one embodiment of this invention, the interlayers comprise at least one catalytic additive.

Membrane geometry may be planar or tubular. There are, however, trade-offs between fabrication and sealing issues. Planar embodiments require a good seal while tubular embodiments are more costly to manufacture.

As previously indicated, one object of this invention is to provide a method for extracting hydrogen from solid hydrocarbon fuels using mixed oxide ion/electronic conducting membranes. Accordingly, the first step in accordance with one embodiment of the method of this invention is the gasification of a solid hydrocarbon fuel to produce a synthesis gas, which synthesis gas comprises hydrogen. The gasification step may be carried out by any of a number of gasification processes known to those skilled in the art. The synthesis gas, direct from the gasification reactor vessel employed in the gasification process, is brought into contact with the first side of a mixed oxide ion/electronic conducting membrane and steam is brought into contact with the opposite side of the membrane, resulting in the formation of hydrogen gas on the steam side of the membrane and water and/or water vapor on the first side of the membrane.

In accordance with one preferred embodiment of this invention, the mixed oxide ion/electronic conducting membrane is disposed within the gasification reactor vessel in which the solid hydrocarbon fuel is being gasified. In this way, hydrogen is extracted from the synthesis gas as the synthesis gas is being produced. By making the hydrogen extraction process an integral part of the gasification process, the costs will be less than if the extraction process were carried out separate and apart from the gasification process.

In accordance with another preferred embodiment of this invention, the mixed oxide ion/electronic conducting membrane system is disposed downstream of the gasification reactor vessel in another vessel that maintains temperature and pressure conditions close to those of the gasification reactor. In this way, the thermodynamic advantages for hydrogen extraction are retained under cleaner conditions than exist in the gasification reactor.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A method for extraction of hydrogen from a solid fuel comprising the steps of:
gasifying said solid fuel in a gasification reactor, producing a synthesis gas comprising said hydrogen;
introducing said synthesis gas directly from said gasification reactor into a hydrogen extraction vessel comprising a mixed oxide ion/electronic conducting membrane having a first side and an opposite second side, said synthesis gas contacting a first side surface of said mixed oxide ion/electronic conducting membrane on said first side of said mixed oxide ion/electronic conducting membrane; and
contacting a second side surface of said mixed oxide ion/electronic conducting membrane on said opposite second side of said mixed oxide ion/electronic conducting membrane with steam, forming at least one of water and steam on said first side of said mixed oxide ion/electronic conducting membrane and extracted hydrogen on said second side of said mixed oxide ion/electronic conducting membrane.

2. A method in accordance with claim 1, wherein said hydrogen extraction vessel is disposed within said gasification reactor.

3. A method in accordance with claim 1, wherein said mixed oxide ion/electronic conducting membrane is selected from the group consisting of a single phase material having both oxide and electronic conductivity, a cermet comprising an oxide ion conductor and a metal electronic conductor, a dual phase ceramic comprising an oxide ion conductor and an electronic conducting oxide and combinations thereof.

4. A method in accordance with claim 1, wherein said mixed oxide ion/electronic conducting membrane comprises at least one catalyst disposed on at least one of said first side surface and said second side surface.

5. A method in accordance with claim 4, wherein said at least one catalyst on said first side surface of said mixed oxide ion/electronic conducting membrane promotes hydrogen oxidation.

6. A method in accordance with claim 4, wherein said at least one catalyst on said second side surface of said mixed oxide ion/electronic conducting membrane promotes steam dissociation.

7. A method in accordance with claim 1, wherein said synthesis gas has a temperature in a range of about 600° C. to about 1400° C.

8. A method in accordance with claim 1, wherein said solid fuel is selected from the group consisting of coal, biomass and mixtures thereof.

9. A method for extraction of hydrogen from a hydrogen-containing gas mixture comprising the steps of:
contacting a first side of a mixed oxide ion/electronic conducting membrane with said hydrogen-containing gas mixture; and
contacting an opposite side of said mixed oxide ion/electronic conducting membrane with steam, forming at least one of water and steam on said first side of said mixed oxide ion/electronic conducting membrane and hydrogen gas on said opposite side of said mixed oxide ion/electronic conducting membrane.

10. A method in accordance with claim 9, wherein said hydrogen-containing gas mixture is a synthesis gas derived directly from gasification of a solid fuel.

11. A method in accordance with claim 10, wherein said synthesis gas has a temperature in a range of about 600° C. to about 1400° C.

12. A method in accordance with claim 10, wherein said mixed oxide ion/electronic conducting membrane is disposed in a solid fuel gasification reactor vessel.

13. A method in accordance with claim 10, wherein said solid fuel is selected from the group consisting of coal, biomass and mixtures thereof.

14. A method in accordance with claim 9, wherein said mixed oxide ion/electronic conducting membrane is selected from the group consisting of a single phase material having both oxide and electronic conductivity, a cermet comprising an oxide ion conductor and a metal electronic conductor, a dual phase ceramic comprising an oxide ion conductor and an electronic conducting oxide and combinations thereof.

15. A method in accordance with claim 9, wherein said mixed oxide ion/electronic conducting membrane comprises at least one catalyst disposed on at least one of said first side and said second side.

16. A method in accordance with claim 15, wherein said at least one catalyst on said first side of said mixed oxide ion/electronic conducting membrane promotes hydrogen oxidation.

17. A method in accordance with claim 15, wherein said at least one catalyst on said second side of said mixed oxide ion/electronic conducting membrane promotes steam dissociation.
